(19) United States
(12) Patent Application Publication
(10) Pub. No.: US 2020/0344303 A1
(43) Pub. Date: Oct. 29, 2020

(54) TRANSMISSION OF SENSOR DATA FROM SENSOR DEVICES

(71) Applicant: SONY CORPORATION, Tokyo (JP)

(72) Inventors: Rickard LJUNG, Helsingborg (SE); Peter ISBERG, Lund (SE); Linh TRANG, Åkarp (SE); Jim RASMUSSON, Vellinge (SE)

(21) Appl. No.: 16/957,077

(22) PCT Filed: May 10, 2018
(86) PCT No.: PCT/EP2018/062167

§ 371 Date: Jun. 22, 2020

(51) Int. Cl. H04L 29/08; H04L 12/26; H04N 19/124; H04N 19/14

(52) U.S. Cl. CPC H04L 67/12; H04L 67/10; H04N 19/14; H04N 19/124; H04L 43/08

(57) ABSTRACT

A sensor device operates in accordance with a method that implements a generic encoder for sensor data. The method comprises: receiving (201) input signal data of one or more sensors; encoding (202) the input signal data into formatted sensor data in a first format; and transmitting (203) the formatted sensor data to a receiving device over a communication channel. The method further comprises: configuring (205), subject to a command, said encoding to generate the formatted sensor data in a second format which differs from the first format. The command may be generated by internal analysis (206) in the sensor device, allowing the formatted sensor data to be automatically adjusted to the input signal data, or by external analysis (207) in the receiving device, allowing external control of the formatted sensor data that is transmitted by the sensor device.

### TECHNICAL FIELD

The present invention relates to processing of data from one or more sensors for transmission over a communication channel.

### BACKGROUND

It is envisioned that the proliferation of Internet-of-Things (IoT) will greatly increase the number of sensors that are installed in various settings and correspondingly increase the amount of sensor data that is transmitted over communication networks. In an exemplifying IoT setting, one or more sensors are associated with a sensor device, by being connected to or incorporated into the sensor device. The sensor device is configured to transmit sensor data to a receiving device, e.g. a server. The configuration of the sensor device is tailored to the specific associated sensors and to the specific use of the sensor data by an application or service at the receiving device. In one example, the sensor device is configured to detect and report specific sensor patterns. For example, a smart watch may be pre-configured to detect, based on signals from one or more accelerometers, activities such as walking, biking, running, etc. The reporting of such sensor patterns is static in its definition. This means that a sensor device is pre-configured to specifically report the activities characterized by the pre-defined patterns. Hence, a new pattern cannot be reported unless the whole communication protocol is modified.

To overcome this limitation, the sensor device may be configured to instead report the signal(s) from the sensor(s), i.e. the raw data, to the receiving device, which then may perform any desired analysis on the signal(s). With such configuration the amount of payload data to transfer to the receiving device may be significantly larger. Such data transmission may be possible in some scenarios. However, in general, there is a need to reduce the amount of payload data that is sent from the sensor device over a communication link to the receiving device, e.g. to increase battery life at the sensor device, to decrease data traffic cost, to reduce the need for storage capacity and processing power at the receiving device, etc. Reducing the amount of payload data may also enable more robust transmission at given amount of data traffic by allocating some of the traffic amount to retransmission, checksums, etc.

There is thus a trade-off between being able to report relevant data to a receiving device and to keep the amount of reported data low.

There is also a general need to facilitate deployment of sensor devices. As noted above, each sensor device needs to be specifically configured to report specific data for a specific sensor and for use by a specific service.

### SUMMARY

It is an objective of the invention to at least partly overcome one or more limitations of the prior art.

Another objective is to facilitate deployment of sensor devices.

Yet another objective is to enable a sensor device to be connected to different types of sensors and/or to provide sensor data for use by different types of services.

One or more of these objectives, as well as further objectives that may appear from the description below, are at least partly achieved by a method, a computer-readable medium, a sensor device and a system according to the independent claims, embodiments thereof being defined by the dependent claims.

A first aspect of the invention is a method, for use in a sensor device. The method comprises: receiving input signal data of one or more sensors; encoding the input signal data into formatted sensor data in a first format; and transmitting the formatted sensor data to a receiving device over a communication channel. The method further comprises: configuring, subject to a command, said encoding to generate the formatted sensor data in a second format which differs from the first format.

In some embodiments, the formatted sensor data in the first format comprises one or more output parameters, and said configuring comprises at least one of: changing a physical unit of at least one of the one or more output parameters; including at least one additional output parameter in the formatted sensor data; switching between generating at least one of the one or more output parameters in a time domain and in a frequency domain; changing frequency content represented by at least one of the one or more output parameters; changing a number of frequency components that are included among the one or more output parameters; changing a dynamic range of at least one of the one or more output parameters; changing a sampling rate of at least part of the input signal data; changing a transmission bit rate of at least one of the one or more output parameters; changing a quantization of at least one of the one or more output parameters; activating a differential coding of at least one of the one or more output parameters; activating a parametric coding of at least one of the one or more output parameters; activating a multiplexing of at least two output parameters when transmitting the one or more output parameters; and controlling an autoencoder to generate at least one of the one or more output parameters by dimensionality reduction.

In some embodiments, said changing a number of frequency components further comprises one of: including only a fundamental frequency of the input signal data among the one or more output parameters, including a set of harmonics of the fundamental frequency among the one or more output parameters, and including a power spectrum representation of the input signal data among the one or more output parameters.

In some embodiments, said changing frequency content is based on masking data, which defines one or more of: a set of frequency ranges to be represented by the one or more output parameters; a quantization within one or more frequency ranges; a time-averaging within one or more frequency ranges; and a number of frequency components within one or more frequency ranges.

In some embodiments, said changing a quantization further comprises modifying a control parameter of a configurable dithering process.

In some embodiments, the command is received from the receiving device. The command may be generated by the receiving device by processing the formatted sensor data in the first format.

In some embodiments, the command is indicative of characteristics of the second format.

In some embodiments, the method further comprises: transmitting, to the receiving device, metadata indicative of characteristics of the second format.

In some embodiments, the method further comprises: performing an analysis of the input signal data to generate the command.

In some embodiments, the command is generated by the sensor device to automatically adapt the formatted sensor data to the input signal data.

In some embodiments, said analysis comprises: processing the input signal data in relation to a set of formatting criteria.

In some embodiments, the set of formatting criteria comprises one or more of: detecting a repeating signal feature in the input signal data; detecting an absence of a characteristic change in the input signal data; determining, in the input signal data, a variability that falls below a variability threshold for a time period; detecting a characteristic change in the input signal data; detecting a change of sensor or sensor type; detecting a change in complexity in the input signal data; detecting a similarity between input signal data of two or more sensors or between two or more output parameters among the one or more output parameters; and detecting a match between a predefined signal pattern and the input signal data.

In some embodiments, said analysis, when detecting the repeating signal feature, generates the command to include an index of the predefined signal pattern in the formatted sensor data or to switch to generating at least one of the one or more output parameters in the frequency domain.

In some embodiments, said analysis, when detecting the absence of a characteristic change, generates the command to reduce transmission bit rate and/or decrease quantization.

In some embodiments, said analysis, when determining the variability below a variability threshold for a time period, generates the command to reduce transmission bit rate and/or decrease quantization.

In some embodiments, said analysis, when detecting the characteristic change, generates the command to increase transmission bit rate and/or increase quantization.

In some embodiments, said analysis, when detecting the change in complexity, generates the command to change at least one of transmission bit rate and quantization.

In some embodiments, said analysis, when detecting the similarity, generates the command to switch to parametric coding.

In some embodiments, said analysis, when detecting the match, generates the command to include an index of the predefined signal pattern among said one or more output parameters.

In some embodiments, said analysis further comprises: obtaining the predefined signal pattern from a pattern database; and said method further comprises one of: transmitting at least part of the pattern database to the receiving device, and receiving at least part of the pattern database from the receiving device.

In some embodiments, the method further comprises: detecting a repeating signal feature in the input signal data, adding a predefined signal pattern corresponding to the repeating signal feature to the pattern database, and including an index of the predefined signal pattern among said one or more output parameters.

In some embodiments, said analysis, when detecting the change of sensor or sensor type, generates the command to switch to one of parametric coding and differential coding.

A second aspect of the invention is a computer-readable medium comprising computer instructions which, when executed by a processing device, cause the processing device to perform the method of the first aspect or any of its embodiments.

A third aspect of the invention is a sensor device configured for connection to one or more sensors and configured to perform the method of the first aspect or any of its embodiments.

A fourth aspect of the invention is a system comprising a sensor device in accordance with the third aspect, and a receiving device configured to receive the formatted sensor data in the first format from the sensor device. The receiving device is further configured to process the formatted sensor data in the first format for detection of a need to change format of the formatted sensor data, determine a second format that differs from the first format, and transmit a command to the receiving device so as to cause the receiving device to generate the formatted sensor data in the second format. Any one of the above-identified embodiments of the first aspect may be adapted and implemented as an embodiment of the second to fourth aspects.

Other objectives, as well as features, aspects and advantages of embodiments of the present invention will appear from the following detailed description, from the attached claims as well as from the drawings.

### BRIEF DESCRIPTION OF DRAWINGS

FIG. 1 illustrates a sensor device in communication with a receiving device.

FIG. 2A is flow chart of an encoder process performed by the sensor device in FIG. 1, and FIGS. 2B-2C are flow charts of analysis processes performed by the sensor device and the receiving device, respectively, in accordance with embodiments.

FIG. 3 is a block diagram of functional modules in the sensor device of FIG. 1 in accordance with an embodiment.

FIG. 4 is a block diagram of an example analyzer module in the sensor device of FIG. 3.

FIG. 5 is a block diagram of an example output generator module in the sensor device of FIG. 3.

FIG. 6 is a sequence diagram of example communication between the sensor device and the receiving device in FIG. 1.

FIGS. 7A-7C show examples of format changes of sensor data transmitted by the sensor device.

FIG. 8 is a block diagram of a sensor device.

### DETAILED DESCRIPTION OF EXAMPLE EMBODIMENTS

Embodiments of the present invention will now be described more fully hereinafter with reference to the accompanying schematic drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. As used herein, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments of the invention.

It will furthermore be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing the scope of the present invention. As used herein, the term “and/or” includes any and all combinations of one or more of the associated listed items.

Well-known functions or constructions may not be described in detail for brevity and/or clarity. Unless otherwise defined, all terms (including technical and scientific terms) used herein have the same meaning as commonly understood by one of ordinary skill in the art to which this invention belongs.

Embodiments of the invention enable a generic encoder for use in sensor devices that may be connected to plural sensors of different types, including sensors providing sensor signals other than audio and video signals. Thereby, embodiments of the invention facilitate deployment of sensor devices. The type of sensors connected may vary over time, and the sensed environment may vary over time. Embodiments of the invention also enable the sensor device to generate formatted sensor data that is automatically adjusted to the sensor signal(s), e.g. to reduce the amount of data that is transmitted to a receiving device while ensuring that the amount of data is sufficient for use by an application or service at the receiving device. Embodiments of the invention also enable the sensor device to change the formatted sensor data under control by the receiving device. Thus, in a broad sense, embodiments of the invention allow the receiving device to control the compression of the sensor data that is transmitted by the sensor device and/or allow the sensor device to automatically adjust the compression of the sensor data to the sensor signal(s) from its sensor(s).

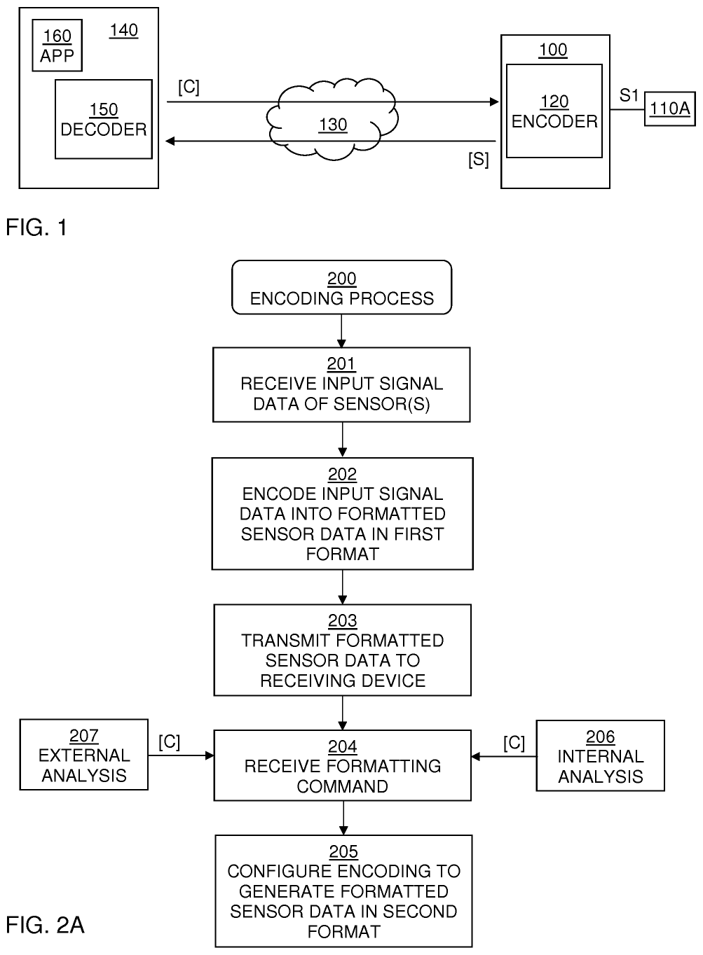

FIG. 1 schematically shows a communications environment for a sensor device 100 which is connected to a sensor 110A. The sensor 110A provides a sensor signal S1 to the sensor device 100. The sensor 110A may be of any conceivable type and sense any conceivable parameter, including but not limited to pressure, heartbeat, temperature, humidity, moisture, light, luminosity, altitude, vibration, sound, acceleration, speed, position, flow rate, concentration, electric current, electric resistance, electric voltage, electric power, frequency, etc. The sensor device 100 comprises an encoder 120 which is configured to encode the sensor signal S1 into formatted sensor data [S] which comprises values of at least one output parameter given by the sensor signal S1. For brevity, the formatted sensor data [S] is denoted “formatted data” in the following. The formatted data [S] is transmitted over a communication channel or link 130 to a receiving device 140. The communication channel 130 may be a wireless channel on a communication network, e.g. comprising any combination of wide area and/or local area and/or personal area networks (WAN/LAN/PAN), or a wired connection. The receiving device 140 comprises a decoder 150 which is configured to receive and decode the formatted data [S] and provide the thus-decoded data to an application or service 160, which may be executed on the receiving device 140, as shown, or on another device. The receiving device 140 may be any type of computer device or group of computer devices, e.g. a local computer, a PLC, server, a cloud computing service, etc.

The encoder 120 and the decoder 150 may but need not be implemented as a combined module, which may be denoted a “codec” by analogy with the terminology used in the context of encoding and decoding of audio and video signals. The encoder 120 and decoder 150 may be implemented by software instructions to be executed by a processor, or by dedicated hardware, or a combination thereof.

In the illustrated embodiment, the receiving device 140 is also configured to generate and transmit, over the communication channel 130, a formatting command [C] to the sensor device 100 to change the encoding of the formatted data [S].

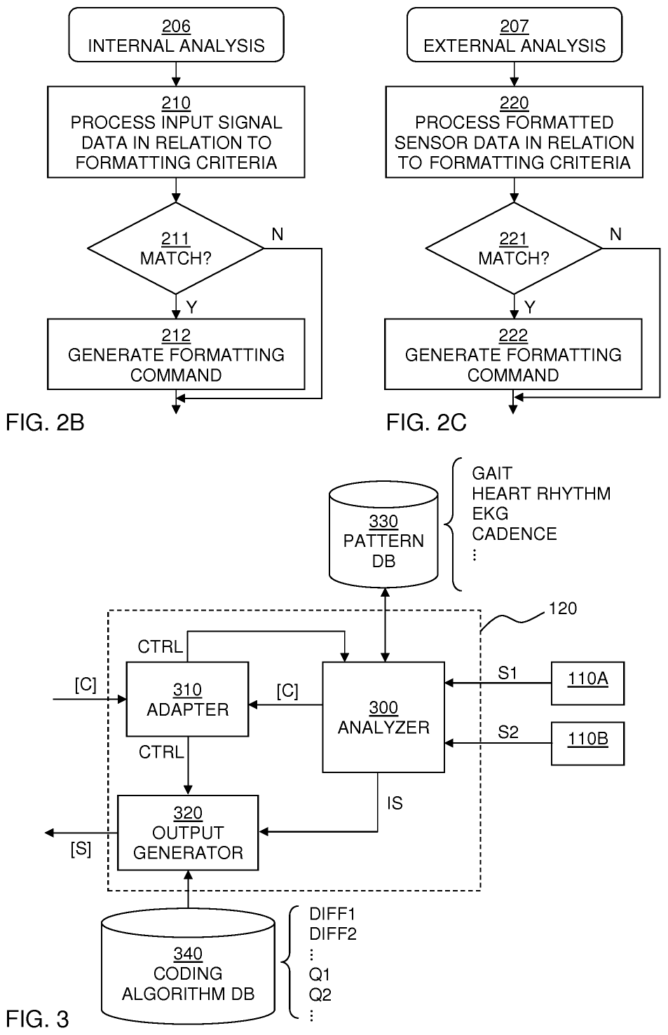

FIG. 2A is a flow chart of an encoding process 200 that is performed by the sensor device 100 in accordance with an embodiment. Step 201 receives or otherwise obtains one or more sensor signals from the one or more sensors that are connected to the sensor device 100, e.g. sensor signal S1 from sensor 110A in FIG. 1. Step 202 encodes the sensor signal(s) into formatted data [S] in a first format, and step 203 transmits the thus-formatted data [S] to the receiving device 140 over the communication channel 130. The formatted data [S] may be transmitted as individual data packets or as a stream of data. Steps 201-203 are then repeated until step 204 receives a formatting command [C], whereupon the encoding process 200 proceeds to step 205, which configures the encoding process to generate formatted data [S] in a second format that differs from the first format. Although not explicitly shown in FIG. 2A, the encoding process 200 then proceeds to encode the sensor signal(s) into formatted data [S] in the second format and transmits the thus-formatted data [S] to the receiving device 140 over the communication channel 130, e.g. until another command [C] causes the sensor device 10 to change the format of the formatted data [S]. As indicated in FIG. 2A, the respective command [C] may be produced as a result of an internal signal analysis 206 in the sensor device 100, or as a result of an external signal analysis 207 in the receiving device 140. The encoding process 200 thus allows the format of the formatted data [S] to be controlled, and thus enables the same encoder 120 to be used to provide formatted data [S] for different services 160 and for different types of sensors 110A, and thus for different types of sensor signals S1.

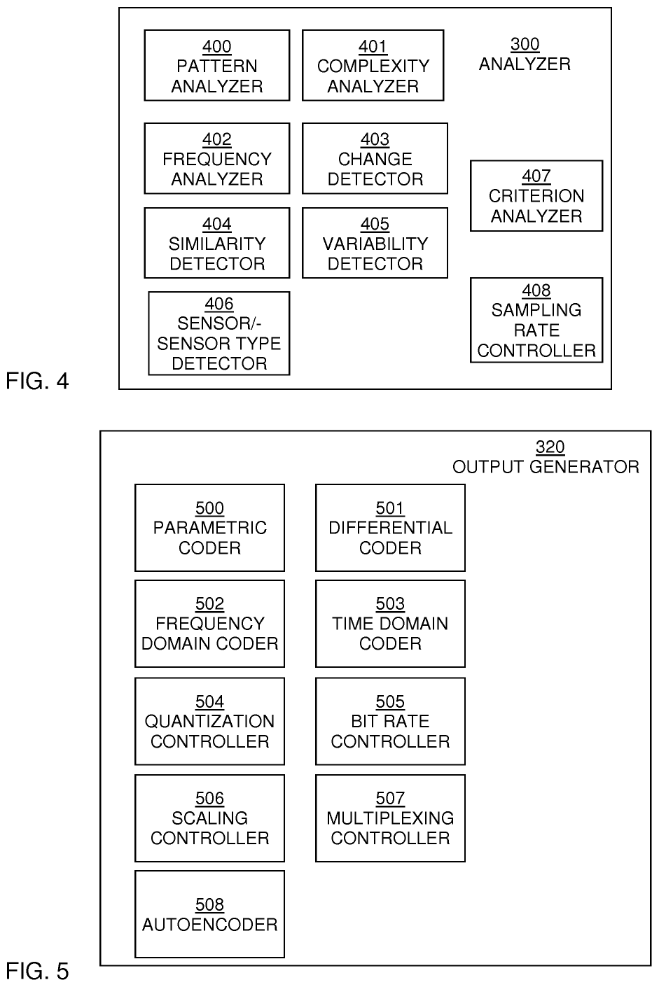

FIG. 2B shows an example of the internal signal analysis 206 that may be performed by the sensor device 100. Step 210 processes the sensor signal(s) in relation to a set of internal formatting criteria. Each internal formatting criterion may be associated with a formatting function, which may represent a specific format or a specific change of the current format of the formatted data [S]. Examples of internal formatting criteria include I1) detecting a repeating signal feature in the sensor signal(s), I2) detecting an absence of a characteristic change in the sensor signal(s), I3) detecting a characteristic change in the sensor signal(s), I4) detecting a change of sensor or sensor type based on the sensor signal(s) or otherwise, I5) detecting a change in complexity in the sensor signal(s), I6) detecting a similarity between sensor signals from two or more sensors or between two or more output parameters obtained from one or more sensor signals, and I7) detecting a match between a predefined signal pattern and the sensor signal(s). Examples of associations between internal formatting criteria and formatting functions are given further below with reference to FIGS. 4-5. If step 211 finds that there is a match to one or more internal formatting criteria, e.g. one or more of I1-I7, the process proceeds to step 212, which generates a command [C] in correspondence with the formatting function(s) associated with the one or more matching formatting criteria. The command [C] thereby causes step 205 to generate the formatted data [S] in the second format. If step 221 finds no match, no command [C] is generated.

It is realized that the internal signal analysis 206 enables the sensor device 100 to automatically adjust the formatted data [S] to the sensor signal(s). Preferably, the sensor device 100 is configured to transmit metadata that identifies, to the decoder 150, the change(s) made to the format of the formatted data [S]. The metadata may be included in the formatted data [S] or transmitted separately from the formatted data [S]. Optionally, the metadata may indicate the reason for the change of format, e.g. by indicating the one or more matching formatting criteria of step 211, i.e. the formatting criterion/criteria that triggered the change.

FIG. 2C shows an example of the external signal analysis 207 that may be performed by the receiving device 140. Step 220 processes the formatted data [S] in the current format in relation to a set of external formatting criteria. Each external formatting criterion may be associated with a formatting function, which may represent a specific format or a specific change of the current format of the formatted data [S]. Examples of the external formatting criteria may correspond to the internal formatting criteria and may thus include E1) detecting a repeating signal feature in the formatted data [S], E2) detecting an absence of a characteristic change in the formatted data [S], E3) detecting a characteristic change in the formatted data [S], E4) detecting a change of sensor or sensor type based on the formatted data [S] or otherwise, E5) detecting a change in complexity in the formatted data [S], E6) detecting a similarity between different output parameters in the formatted data [S], and E7) detecting a match between a predefined signal pattern and the formatted data [S]. If step 221 finds that there is a match to one or more external formatting criteria, e.g. one or more of E1-E7, the process proceeds to step 222, which generates a formatting command [C] in correspondence with the formatting function(s) associated with the one or more matching formatting criteria. The command [C] thereby causes step 205 to generate the formatted data [S] in the second format. If step 221 finds no match, no command [C] is generated. However, it is also conceivable that step 222 may be triggered by other events. In one example, the service 160 may request a specific format or a specific change of format independent of the formatted data [S]. In another example, the receiving device 140 may process formatted data [S] from a plurality of sensor devices 100 and decide that the format of the formatted data [S] from one or more of the sensor devices 100 should be changed to a specific format or in a specific way. Thus, in this example, big data is combined to identify a need to change the format of the formatted data [S].

It is realized that the external signal analysis 207 enables the receiving device 140 (decoder side) to request the encoder 120 to change its output parameters, the reported amount of data, etc. The receiving device 140, e.g. a cloud computing service, may also take into account available data from other sensors, which e.g. makes it more tolerable to request a lower rate and/or resolution from a specific sensor or sensor device. If the sensor device 100 includes a neutral network, the receiving device 140 may request a change of weights used by the neural network or a change of the structure of the neural network.

FIG. 3 is a block diagram of an encoder 120 in accordance with an embodiment. In the illustrated example, the encoder 120 is arranged to receive sensor signals S1, S2 from two sensors 110A, 110B. The encoder 120 comprises three functional modules: an analyzer 300, an adapter 310 and an output generator 320.

The analyzer 300 is configured to perform the internal analysis 206 of FIG. 2B. Thus, the analyzer 300 may process the sensor signals S1, S2 and generate a formatting command [C]. As indicated in FIG. 3, the analyzer 300 is also arranged to provide intermediate data IS to the output generator 320. This intermediate data IS may comprise one or more of the sensor signals S1, S2 or data derived therefrom by the analyzer 300. As indicated in FIG. 3, the analyzer 300 may further be responsive to a control signal CTRL generated by the adapter 310. The control signal CTRL may cause the analyzer 300 to selectively change the internal analysis 206, e.g. to update the formatting criteria or to change the acquisition of the sensor signals S1, S2. The analyzer 300 may also access a pattern database 330, which contains a plurality of different signal patterns that may be detected in one or more of the sensor signals S1, S2 or in a signal generated from the sensor signals S1, S2. As exemplified in FIG. 3, the signal patterns may be associated with gait, heart rhythm, ECG, cadence, etc. The pattern database 330 may be accessed for pattern matching, as will be described further below with reference to FIG. 4.

The output generator 320 is configured to process the intermediate data IS from the analyzer 300 to generate the formatted data [S] for transmission to the receiving device 140 over the communication channel 130 (FIG. 1). The control signal CTRL may cause the output generator 320 to selectively change, in accordance with the control signal CTRL, the format of the formatted data [S]. As shown, the output generator 320 may access an algorithm database 340, which contains a plurality of different coding algorithms, e.g. one or more algorithms for differential coding, DIFF1, DIFF2, one or more algorithms for quantization Q1, Q2, etc.

The adapter 310 is configured to be responsive to a formatting command [C], which may be received via the communication channel 130 and thus be generated by the external analysis 207, e.g. in the receiving device 140, or may be received from the analyzer 300. The adapter 310 is configured to, in response to the command [C], generate the control signal CTRL for the analyzer 300 and/or for the output generator 320.

FIG. 4 is a block diagram of the analyzer 300 in accordance with an embodiment. The analyzer 300 comprises functional sub-modules 400-406, which are configured to perform a respective type of analysis of one or more target signals, e.g. one or more sensor signals S1, S2 and/or one or more signals derived therefrom. Generally, the targets signal(s) may be seen to form “input signal data” for the analyzer 300 in the sensor device 100. The analyzer 300 also comprises a criterion analyzer 407 that may implement one or more of the above-mentioned formatting criteria 11-17, and a controller 408 for setting the sampling rate of the respective sensor signal (S1, S2 in FIG. 3). It is to be understood that FIG. 4 is merely given as an example and that the analyzer 300 may contain any combination of the sub-modules 400-408. At least a subset of the sub-modules 400-408 is responsive to the control signal CTRL from the adapter 310 (FIG. 3). For example, the control signal CTRL may activate/deactivate a sub-module or change a setting or configuration of a sub-module. The control signal CTRL may also define the target signal(s) to be processed by the respective sub-module. Below, the functionality of the respective sub-module will be briefly described and exemplified.

Sub-module 400 is a pattern analyzer or pattern recognizer, which is configured to detect one or more signal patterns in a target signal. In one embodiment, the pattern analyzer 400 is configured to perform pattern matching, by comparing the target signal to signal patterns stored in the pattern database 330. The signal patterns may also be denoted “codes” and the pattern database 330 may be seen to form a “codebook”, by analogy with audio and video codecs. Upon detection of a matching code, the pattern analyzer 400 may generate corresponding intermediate data (IS in FIG. 3) for the output generator 320. The intermediate data may include a code index that represents the matching code and, optionally, data representing the timing of the matching code. In the example of cadence, the intermediate signal may indicate the timing of individual revolutions (each given by a matching code) or a pedalling rate (obtained from a time sequence of matching codes).

In one embodiment of the pattern matching, the pattern analyzer 400 implements a learning process for updating the codebook 330. For example, the learning process may analyze the outcome of the comparison to the codes in the codebook 330 for detection of non-matching signal patterns in the target signal(s). If such a non-matching signal pattern becomes common, according to any suitable criterion, the learning process may add the non-matching signal pattern as a new code in the codebook 330. When adding the new code, the learning process may (but need not) remove an existing code from the codebook 330, e.g. a code that is rarely matching. Thus, the learning process may track the match rate for the individual codes in the codebook 330 for this purpose. When the codebook 330 is updated, the pattern analyzer 400 is also configured to cause the sensor device 100 to transmit metadata comprising a description of the new code to the receiving device 140, which is operable to configure the decoder 150 accordingly (FIG. 1). Thereby, the encoder 120 and the decoder 150 share a dynamic codebook.

In one embodiment, which may be combined with the foregoing embodiment, the sensor device 100 is configured to receive a new code from the receiving device 140, which has updated its decoder 150 with the new code. Upon receipt of the new code, the pattern analyzer 400 updates the codebook 330 with the new code. Thereby, the encoder 120 and the decoder 150 share a dynamic codebook.

The pattern analyzer 400 need not utilize pattern matching. In an alternative embodiment, the pattern analyzer 400 is configured to detect a repeating signal pattern in the target signal by use of an autoencoder, which comprises an artificial neural network used for unsupervised learning of efficient coding. An autoencoder comprises one or more configurable encoders and one or more configurable decoders and is operable to learn to compress a first signal at its input layer into a short code and then uncompress that code into a second signal at its output layer so that the second signal closely matches the first signal. A repeating pattern may be detected in a target signal by providing it to the input layer of the autoencoder, and by comparing the resulting signal at the output layer to the target signal, e.g. by computing a difference measure such as mean-square-error (MSE) or an equivalent estimator, etc. If the difference measure is below a threshold, the pattern analyzer 400 may output an indication that a repeating signal pattern has been detected.

Sub-module 401 is a complexity analyzer, which is configured to analyze the complexity of the target signal(s) and output a corresponding complexity index. Complexity detection is well-known in the art and any suitable complexity measure may be used, such as various entropy measures. Also simpler examples of complexity detection may be possible, such as analysing variations in target signal amplitude or phase and perform variance estimations, etc.

Sub-module 402 is a frequency analyzer, which is configured to analyze the target signal(s) for determining of its frequency content, e.g. energy or power spectral density, and output corresponding frequency data. Frequency analysis (spectrum analysis) is well-known in the art and the sub-module 402 may implement any known technique or combination of techniques, e.g. Fourier transformation, FFT (Fast Fourier Transformation), wavelet transformation, etc.

Sub-module 403 is a change detector, which is configured to analyze the target signal(s) for detection of a characteristic change and output a corresponding change indicator. The change detector 403 may be configured for processing of a target signal which is generated in the frequency domain, in which the characteristic change may be a change in the frequency content, e.g. a change in relative power of the most significant frequencies, a change of the most significant frequencies, a change in signal variability, etc. Alternatively or additionally, the change detector 403 may be configured for processing of a target signal which is generated in the time domain, in which the characteristic change may be a step change or other characteristic signal pattern, a signal change in relation to one or more threshold levels, a change in signal variability, etc.

Sub-module 404 is a similarity detector, which is configured to determine a similarity between two or more target signals and output a corresponding similarity index. Depending on implementation and target signals, the similarity detector 404 may e.g. determine the similarity index by cross-correlating the target signals, by calculating a difference measure between corresponding signal values in the target signals, e.g. mean-square-error (MSE) or an equivalent estimator, etc.

Sub-module 405 is a variability detector, which is configured to determine the variability of a target signal and output a corresponding variability index. The variability detector 405 may determine the variability index by any suitable statistical analysis of the target signal, e.g. by computation of variance, range, standard deviation, etc.

Sub-module 406 is configured to determine the sensor or sensor type that produces the respective sensor signal and output a corresponding sensor index. The sensor detector 406 may detect the sensor or sensor type by analysing the respective sensor signal and/or based on identification data provided by the respective sensor.

It should be noted that the sub-modules 400-406 may be operable to process different target signal(s). In one embodiment, the target signal(s) to be processed is at least partly set by the control signal CTRL from the adapter 310 (FIG. 3). It should also be noted that the target signal(s) of one sub-module may be given by the output of another sub-module. For example, the pattern analyzer 400, the complexity analyzer 401, the change detector 402 or the similarity detector 404 may operate on frequency data that is output by the frequency analyzer 402.

Sub-module 407 is a criterion analyzer, which is configured to operate on the output of one or more of the sub-modules 400-406 to evaluate one or more formatting criteria, e.g. one or more of I1-I7 as exemplified above. Thus, the criterion analyzer 407 associates each formatting criteria with a respective formatting function. When a formatting criterion is found to be fulfilled, the criterion analyzer 407 generates a corresponding formatting command [C] for receipt by the adapter 310 (FIG. 3). For example, a repeating signal feature in the sensor signal (criterion I1) may be detected by the pattern analyzer 400 operating on the sensor signal or the frequency data from the frequency analyzer 402. A change in complexity (criterion IS) may be detected by operating the change detector 403 on the output of the complexity analyzer 401. A similarity between sensor signals or time sequences of output parameters (criterion 16) may be detected by the similarity detector operating on the appropriate target signals. This is just a few examples. Any of the formatting criteria 11-17, and other formatting criteria, may be implemented in different ways by use of the sub-modules 400-407.

Sub-module 408 is a sampling rate controller, which is configured to set the sampling rate of the respective sensor signal.

FIG. 5 is a block diagram of the output generator 320 in accordance with an embodiment. The output generator 320 comprises functional sub-modules 500-508, which are configured to perform different functions for generating the formatted data [5]. At least a subset of the sub-modules 500-508 is responsive to the control signal CTRL from the adapter 310 (FIG. 3). For example, the control signal CTRL may activate/deactivate a sub-module, cause a sub-module to retrieve and use a specific algorithm from the algorithm database 340 (FIG. 3), or change a setting or configuration of a sub-module. The control signal CTRL may also define the set of signals to be processed by the respective sub-module, e.g. among the intermediate data IS provided by the analyzer 300. It should be understood that any combination of the sub-modules 500-508 may be active at the same time to generate the formatted data [S]. Below, the functionality of the respective sub-module will be briefly described and exemplified. Sub-module 500 is a parametric coder, which is configured to compress one or more incoming data streams into one or more streams of parameters that represent features of the one or more incoming data streams, such that the stream(s) of parameters enable a corresponding parametric decoder to recreate the incoming data stream(s). Thus, the parametric coder 500 generates formatted data [S] comprising one or more parametric streams (time sequences) of representative parameters. In one embodiment, the parametric coder 500 is configured to generate one of more main data streams based on a subset of multiple incoming data streams and to represent the remaining data streams by one or more parametric streams of representative parameters that describe the relation between the incoming data streams and the main data stream(s). In this embodiment, the formatted data [S] comprises the main data stream(s) and the parametric stream(s). Parametric coding is well-known in the field of audio encoding (stereo, surround sound, etc) but has not been considered for encoding of formatted sensor data.

As a non-limiting example of the parametric coding, consider accelerometer data in three directions (e.g. [x,y,z]). It is not uncommon that there is similarity or correlation between the accelerometer data in two or more directions, which would enable compression by parametric coding. In one example, the main stream may be generated as the sum of the accelerometer data for all directions, and parametric streams may be generated to represent the various dimensions. In another example, the z direction may be the main stream, and parametric streams may be generated to represent the other two dimensions. As another non-limiting example of the parametric coding, consider one or more sensors arranged to report the positions of a plurality of positioning probes, i.e. multiple locations in two dimensions (e.g. [x,y]). In one example, the main stream may be generated to represent one of the locations and parametric streams may be generated to represent the other locations relative to the location in the main stream.

The skilled person realizes that the parametric stream(s) may be encoded into fewer bits and therefore one can reduce the amount of transferred data from the sensor device without losing significant information from the incoming data stream(s).

Sub-module 501 is a differential coder, which is configured to compress a signal by encoding the difference between the signal and its prediction in the formatted data [S]. Differential coding is well-known in video and audio codecs and is also known as predictive coding. Any prediction function may be used, e.g. a linear function. The prediction may also be adaptive (forward or backward). In a simple embodiment, the difference in amplitude to previous sample(s) is encoded, possibly with adaptive step size. The differential coder 501 may be selectively activated and deactivated by the control signal CTRL from the adapter 310. It is also conceivable that the control signal CTRL causes the differential coder 501 to switch between different types of differential coding. In one example, as indicated in FIG. 3, the differential coder 501 may retrieve a specific coding algorithm DIFF1, DIFF2 from the algorithm database 340. In another example, the differential coder 501 may modify its differential coding by changing the prediction function, step size, etc.

Sub-module 502 is a frequency domain coder, which is configured to encode frequency data (e.g. from the frequency analyzer 402 in FIG. 4) into the formatted data [S]. The frequency domain coder 502 may be selectively activated and deactivated by the control signal CTRL from the adapter 310. It is also conceivable that the control signal CTRL causes the coder 502 to change the amount of frequency data that is encoded into the formatted data [S]. For example, subject to the control signal CTRL, the coder 502 may be controlled to increase or decrease the amount of frequency information in the formatted data [S]. As a non-limiting example, consider a microphone or accelerometer mounted on a machine. As long as everything is normal, it is enough for the sensor device 100 to report a limited amount of frequency data, e.g. the fundamental frequency of the machine. Thus, in a default state, the coder 502 may be configured to encode only a fundamental frequency into the formatted data [S]. If an unusual structure of the frequency harmonics is detected, it may be relevant to also describe the harmonic structure. Thus, upon detection of an anomaly, the coder 502 may be controlled to include in the formatted data [S] also the most prominent harmonics of the fundamental frequency and/or the most prominent frequency components, or even a full power spectrum. It is further conceivable that the control signal CTRL causes the coder 502 to change the physical unit of the frequency data, e.g. between Hz, BPM, RPM, etc.

Depending on application 160 (FIG. 1), it may be efficient to represent the frequency data in the formatted data [S] as a set of relatively wide sub-bands. The quantization can be different for each sub-band, depending on the application 160. Also the time-averaging of each sub-band might be different. By performing such operation, the data can for example be divided into sub-bands or sub-parts, where each such sub-part represents a respective frequency range. One use case for such operation may be when performing analysis of audio data from a microphone sensor or similar, where the data can be divided into sub-parts depending on the frequency range, e.g. taking into account that the human capability to detect different frequencies typically have a certain characteristics. By performing different quantization per frequency range, the level of detail may differ within in a data stream, ensuring e.g. for audio that the highest amount of detail is available for the frequency range where the human ear has the highest sensitivity such as in the range between 3000-5000 Hz. In other use cases, the data may be formatted by conducting an averaging over time, e.g. using a sliding window technique. When modifying the time-averaging per sub-band, the length of the sliding window may differ between the sub-bands.

Although the foregoing discussion refers to audio data, the principle of representing frequency data in the formatted data [S] as a set of sub-bands and, optionally, applying an individual quantization and/or time-averaging to the respective sub-band is applicable to any type of sensor signal(s) from any type of sensor(s). It is realized that the selection of sub-bands and the quantization/time-averaging in the respective sub-band may generally be adapted to limitations and/or requirements of the application 160 that operates on the formatted data [S]. Generally, this means that, depending on the application 160, there may be masking effects reducing the importance of certain frequency ranges (sub-bands). The frequency domain coder 502 may be configured to apply a masking model, which is configured for the application 160 to indicate what sub-bands of the sensor signal(s) that can be more sparsely coded or even discarded. A masking model, in this context, describes a frequency limitation of the application 160 that will consume the formatted data [S]. The encoder 120 may therefore safely discard surplus data, because it will not be relevant for the performance of the application 160. Thus, the frequency domain coder 502 may be controlled, by the control signal CTRL, to apply a masking model when encoding frequency data into the formatted data [S]. The sensor device 100 may store a plurality of masking models, e.g. in the algorithm database 340, and the coder 502 may be controlled to retrieve and apply a specific masking model based on the control signal CTRL. In one embodiment, the sensor device 100 is configured to receive a masking model from the receiving device 140. Upon receipt, sensor device 100 stores the masking model, e.g. in the algorithm database 340, for retrieval by the coder 502. For example, the masking model (“masking data”) may define one or more of a set of frequency ranges (sub-bands) to be represented in the formatted data [S] (thereby excluding one or more other frequency ranges), a quantization within one or more frequency ranges, a time-averaging within one or more frequency ranges, and a number of frequency components to be included in the formatted data [S] within one or more frequency ranges.

Sub-module 503 is a time domain coder, which is configured to encode time domain data into the formatted data [S]. The time domain coder 503 may encode the time domain data to represent, e.g., the sensor signal(s) or any signal derived therefrom, optionally after having applied of a modifying function thereto, e.g. an averaging function, power function, logarithmic function, etc. The time domain coder 503 may be selectively activated and deactivated by the control signal CTRL. Further, the control signal CTRL may cause the coder 503 to operate on a specific set of signals, e.g. among the intermediate data IS provided by the analyzer 300. It is also conceivable that the control signal CTRL causes the time domain coder 503 to change the above-mentioned modifying function and/or change the physical unit of the time domain data.

Sub-module 504 is a quantization controller 504, which is configured to set the quantization of one or more output parameters in the formatted data [S]. The quantization controller 504 may be set, by the control signal CTRL, to apply specific quantization when encoding the output parameter(s). The control signal CTRL may e.g. set the number of bits of the quantization and/or switch between linear quantization (equidistant steps as in linear PCM), logarithmic quantization (as in A-law G.711 PCM), or any other mapping between incoming data and the formatted data [S]. In one example, as indicated in FIG. 3, the controller 504 may retrieve a specific quantization algorithm Q1, Q2 from the algorithm database 340.

In one embodiment, the quantization controller 504 may represent a signal value by: a sign bit, and n magnitude bits mapped as xₒᵤₜ=Qₖ (logₘ xᵢₙ) or xₒᵤₜ=Qₖ(Xᵢₙ^{m}), where Qₖ represents a quantizer in k steps, m is a configurable parameter, and xᵢₙ is the absolute value of the signal value being represented. The signal value may, e.g. represent an instant amplitude from a sensor, a magnitude of a frequency-domain component, or any other quantitative data derived from the sensor signal(s).

Generally, by use of the quantization controller 504, the formatted data [S] may be quantized so that no more bits than necessary are used, given the requirements of the application 160.

In one embodiment, the quantization controller 504 implements a dynamic approach, in which the controller 504 sets a control parameter of a configurable dithering process, e.g. to employ simple rounding or use a specific dithering to increase the practically usable dynamic range, adapt its statistical amplitude distribution or push the dithering noise to a part of the spectrum that is most suitable for the application 160. In audio applications, such as mastering for CD, sigma-delta A/D converters etc, it is known that the addition of dithering noise before rounding to a limited bit depth can beneficial. Audio productions are typically produced in high-resolution production environments and the dithering noise is applied as the very last stage before rounding to a format that fits the distribution medium, e.g. 16 bit CD format. Moreover, the characteristics of the dithering noise may be of importance, such as its statistical amplitude distribution (e.g. triangular, rectangular, Gaussian) and its frequency spectrum. “Noise shaping” is often employed in audio applications considering the frequency-dependent behaviour of the human auditory system. While the dithering noise reduces perceived effects from quantization distortion, care must be taken to make the dithering noise unlikely to be audible. For a given dithering noise amplitude, its spectral shape may be constructed for minimum audibility. Dithering noise can also be used for images. For a particular sensor application 160, certain statistical distributions and noise shaping may be beneficial. The target consumption may be the human auditory or visual system, a different human sensory system or machine analysis. The statistical amplitude distribution and spectral shape is adapted to the intended application 160. The selection of the control parameter of the dithering process, and thus suitable dithering characteristics, may be done by command from the receiving device 140 or it may be autonomously decided by the sensor device 100 itself, being cognisant of the application 160 and the signal characteristics. The sensor device 100 may make this adaptation based on the measured parameter range of the sensor signal(s).

Sub-module 505 is a bit rate controller, which is configured to set the coding rate of one or more output parameters in the formatted data [S], and thereby also the transmission bit rate of the sensor device 100. The bit rate controller 505 may be set, by the control signal CTRL, to apply a specific bit rate. Thereby, the bit rate may be changed in accordance with any property detected by the analyzer 300, such as a characteristic change the sensor signal(s) or any signal(s) derived therefrom, or the complexity of any such signal(s). Thus, the bit rate controller 505 may be controlled to generate a variable bit rate of the formatted data [S] in dependence of a property of the sensor signal(s).

Sub-module 506 is a scaling controller, which is configured to set the dynamic range of one or more output parameters in the formatted data [S]. The dynamic range controller 506 may be set, by the control signal CTRL, to apply a specific dynamic range. Thereby, the dynamic range may be changed in accordance with any property detected by the analyzer 300.

Sub-module 507 is a multiplexing controller, which is configured to include data from multiple sources into a container format allowing transmission and/or storage of values of a variety of output parameters, in a single file or stream. Preferably, the container format is configured to allow efficient reading of only a subset of the total file or stream. The multiplexing controller 507 may, e.g., perform data interleaving or indexation of data from different sources within the container format. The controller 507 may be selectively activated and deactivated by the control signal CTRL. It is also conceivable that the control signal CTRL causes the controller 507 to switch between different types of container formats and/or between generating a file and a stream of data.

Sub-module 508 comprises an autoencoder and is thus content adaptive. The autoencoder 508 is trained to learn a representation (encoding) for a set of data, typically for the purpose of dimensionality reduction. As described above, an autoencoder is configured to learn to compress data from its input layer into a short code and then uncompress that code into something that closely matches the original data. This forces the autoencoder to engage in dimensionality reduction. The short code generated by the trained autoencoder 508 thus forms encoded/compressed data that may form or be included in the formatted data [S]. The autoencoder 508 may be trained before and/or after installation in the sensor device 100. The autoencoder 508 may also be configurable, e.g. with respect to the number of output parameters, compression rate, deep learning architecture, etc. The autoencoder 508 may be selectively activated and deactivated by the control signal CTRL and/or be configurable by the control signal CTRL.

Based on the foregoing description with reference to FIG. 5, it is realized that the encoder 120 is configurable, subject to a command [C] from the receiving device 140, to operate in a multitude of different ways to generate the formatted data [S] based on the sensor signal(s). Based on the foregoing description with reference to FIG. 4, it is also realized that the encoder 120 may be configured in a multitude of ways to automatically adjust the format of the formatted data [S] to changes in the sensor signal(s).

In the following a few non-limiting examples of automatic adjustments of the encoder 120 are given.

In one example, a detection of a predefined signal pattern in a target signal (e.g. by pattern analyzer 400) causes the encoder 120 to replace the predefined signal pattern by a corresponding index (e.g. code index) in the formatted data [S].

In one example, a detection of a repeating signal pattern in a target signal (e.g. by pattern analyzer 400 or frequency analyzer 402) causes the encoder 120 to switch from encoding the formatted data [S] in the time domain to encoding the formatted data [S] in the frequency domain.

In one example, detection of a low variability in a target signal (e.g. by variability detector 405 detecting a variability below a threshold value), during a predefined or configurable time period, causes the encoder 120 to reduce the bit rate and/or decrease the quantization of the formatted data [S]. It is even conceivable that the encoder 120 is caused to refrain from generating any formatted data [S]. In a non-limiting example, consider a set of sensors on a machine in a factory. If the sensor signals from the set of sensors have a certain characteristic during a few hours, it may be sufficient for the encoder 120 to send formatted data [S] in the form of a single (or a few) data package(s) during this time period. If something happens that cause signals/characteristics to change sufficiently (e.g. detected by change detector 403 or variability detector 405), the encoder 120 may be instantly caused to send formatted data [S] in the form a new data package. This enables the encoder 120 to operate with a signal characteristic adaptive variable time interval.

Thus, as understood from the foregoing example, a detection of a characteristic change in a target signal (e.g. by change detector 403) may cause the encoder 120 to increase the bit rate and/or increase the quantization of the formatted data [S].

In one example, a detection of a change in complexity of a target signal (e.g. by complexity detector 401) causes the encoder 120 to change the bit rate and/or or the quantization, where a decreased complexity may result in a decreased bit rate and/or quantization, and vice versa.

In one example, a detection of connection of plural accelerometers (e.g. by detector 406) causes the encoder 120 to switch to parametric coding.

In one example, a detection of connection of an image sensor (e.g. by detector 406) causes the encoder 120 to switch to differential coding.

In one example, a detection of a similarity between target signals (e.g. by similarity detector 404) causes the encoder 120 to switch to parametric coding.

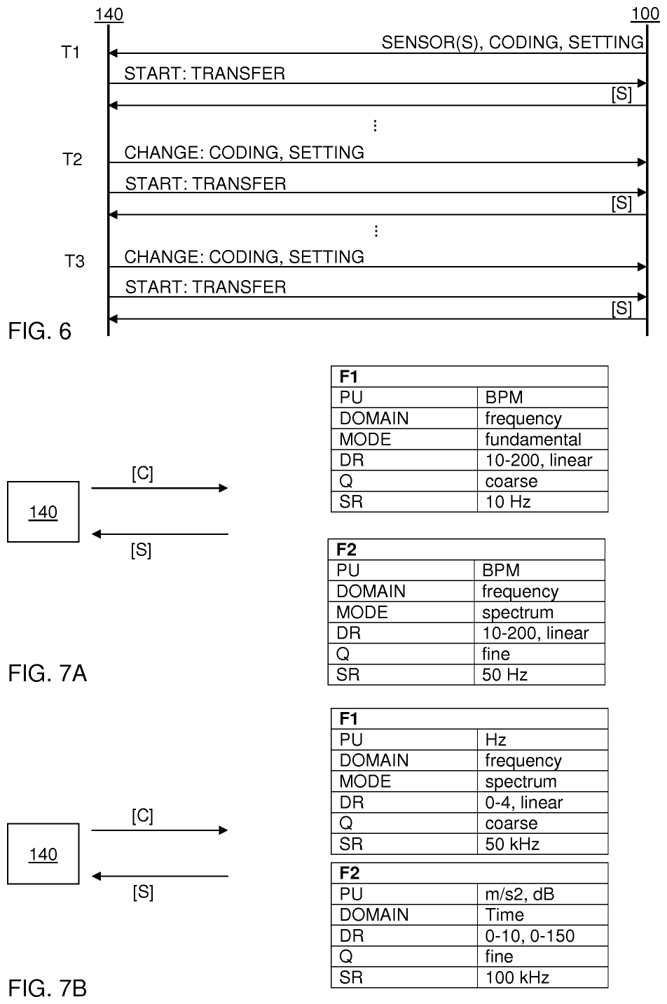

FIG. 6 is a sequence diagram for communication between a sensor device 100 and a receiving device 140 in an example. At time point T1, the sensor device 100 starts by transmitting metadata that indicates its sensing capabilities and a proposed formatting of the formatted data [S]. As shown, the metadata may identify the sensor(s) and/or sensor type(s) that are connected to the sensor device 100, a proposed coding and a proposed setting, e.g. sampling rate, scaling, quantization, the output parameters to be included in the formatted data [S], etc. Upon receipt of the metadata, the receiving device 140 may accept the proposed format of the formatted data [S], by returning a start command to the sensing device 100, and configure its decoder 150 (FIG. 1) for decoding the formatted data [S]. The start command causes the sensor device 100 to transmit the formatted data [S] in the proposed format. Alternatively, not shown, after evaluating the metadata in relation to the requirements of the service 160 (FIG. 1), the receiving device 140 may return a command [C] for a different format of the formatted data [S] and configure the decoder 150 accordingly. At a second time point T2, the receiving device 140 detects a need to change the format of the formatted data [S] and transmits a corresponding command [C] to the sensor device 100. In the illustrated example, the command [C] requests a change of coding (e.g. a switch between any of the coders 500-503 in FIG. 5 or a change of the algorithm used by any of the coders 500-503) and a change of setting (e.g. a change of setting for any of sub-modules 500-508 in FIG. 5 and/or sub-modules 400-408 in FIG. 4). Optionally after receiving an acknowledgment from the sensor device 100, the receiving device 140 then transmits a start command to the sensing device 100 and configures the decoder 150 in accordance with the new format of the formatted data [S]. The start command causes the sensor device 100 to transmit the formatted data [S] in the new format. The foregoing procedure is then repeated at a third time point T3, at which the receiving device 140 requests another change of format of the formatted data [S].

It should be noted that, depending on application 160, initialization parameters may be exchanged between the sensor device 100 and the receiving device 140, e.g. setting the time base, initial codes of the codebook, maximum delays in the encoder 120 and the decoder 150, etc.

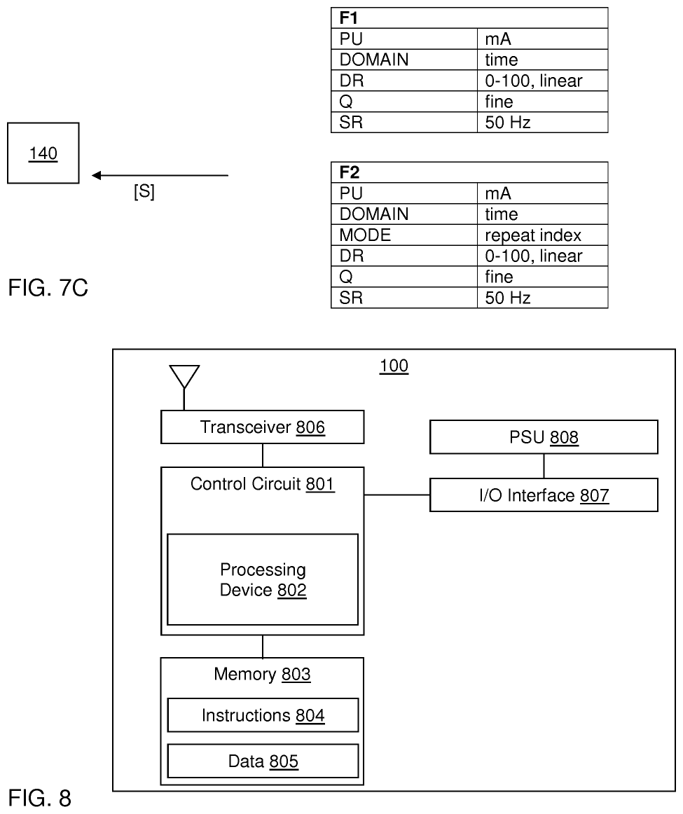

To further exemplify embodiments of invention, FIGS. 7A-7C show examples of how formatted data [S] may be changed from a first format F1 to a second format F2.

FIG. 7A may represent formatted data [S] from a sensor device 100 which is configured to operate as a heart rate meter based on a sensor signal from a pulse sensor. In a default configuration, the sensor device 100 may transmit formatted data [S] in a first format F1: including only the fundamental frequency of the heartbeats, given in physical unit (PU) BPM (beats per minute), with a dynamic range (DR) of 10-200 BPM in linear scaling, a coarse quantization (Q) and a sampling rate (SR) of 10 Hz. The sensor device 100 streams the formatted data [S] to the receiving device 140, which operates AI (Artificial Intelligence) on the formatted data [S] for evaluation. Based on this evaluation and by mining other medical data about the person wearing the pulse sensor, the AI identifies a need to examine the heartbeats in more detail. The AI causes the receiving device 140 to transmit a dedicated formatting command [C] to the sensor device 100, requesting a change of sampling rate to 50 Hz, frequency data in spectrum mode, and fine quantization. The command [C] causes the sensor device 100 to start transmitting the formatted data [S] in a format F2 that corresponds to the command [C]. The request for spectrum mode may cause the sensor device 100 to transmit a power spectrum of the sensor signal with light compression. The AI receives and analyzes the formatted data [S] in the second format F2. If no medical issue is detected, the AI may cause the receiving device 100 to transmit a command [C] for a change back to the default configuration, to save battery in the sensor device 100.

FIG. 7B may represent formatted data [S] from a sensor device 100 which is connected to receive sensor signals from accelerometers and microphones arranged on an industrial manufacturing machine. The sensor device 100 has a default configuration, in which the sensor signals are analyzed with respect to a set of formatting criteria that represents potential operational errors. As long as operation is normal, the sensor device 100 does not transmit any data to the receiving device 140. If the analysis indicates a potential error, e.g. a broken bearing, the sensor device 100 automatically configures its encoder 120 to transmit formatted data [S] in a first format F1: including frequency data from the specific accelerometer(s) indicating the potential error in spectrum mode in physical unit Hz, with a dynamic range of 0-4 Hz in linear scaling, a coarse quantization (Q) and a sampling rate (SR) of 50 kHz. The application 160 in the receiving device 140 receives the formatted data [S] but is unable to determine whether the bearing is broken. The application 160 therefore causes the receiving device 140 to transmit a formatting command [C] requesting a change to time domain coding, a fine quantization, a sampling rate of 100 kHz and a recording time of 5 seconds. The command [C] also requests data from the microphones with a dynamic range of 0-150 dB. The command [C] causes the sensor device 100 to start transmitting the formatted data [S] in a format F2 that corresponds to the command [C], thereby allowing an in-depth analysis of the potential error at the receiving device 100, e.g. by AI or a human operator.

FIG. 7C may represent formatted data [S] from a sensor device 100 which is connected to receive a sensor signal from a pulse sensor. Initially, the sensor device 100 transmits formatted data [S] in a first format F1: generated in the time domain to represent the sensor signal in mA with a dynamic range of 0-100 mA, a fine quantization and a sampling rate of 50 Hz. After some time, the sensing device 100 detects that the sensor signal contains a repetitive signal pattern. This causes the sensor device 100 to automatically configure its encoder 120 to transmit the formatted data [S] in a second format F2, in which each instance of the signal pattern is replaced by a repetition indicator. The repetition indicator may be the above-mentioned code index (cf. pattern analyzer 400 in FIG. 4). The receiving device 100 is thereby able to insert the signal pattern at the locations of the repetition indicator to recreate the sensor signal from the pulse sensor.

In the following, an example structure of the sensor device 100 will be described with reference to the block diagram in FIG. 8. In the illustrated example, the sensor device 100 comprises a control circuit or control unit 801, a memory 803, and a transceiver 806. The control circuit 801 is responsible for the overall operation of the sensor device 100 and may comprise any commercially available processing device 802, such as a CPU (“Central Processing Unit”), DSP (“Digital Signal Processor”), microprocessor or other electronic programmable logic device, or combination thereof. The control circuit 801 may be implemented using instructions that enable hardware functionality, e.g. executable computer program instructions 804 that may be stored on the memory 803. The processing device 802 may be configured to read the instructions 804 from the memory 802 and execute these instructions to control the operation of the sensor device 100, e.g. to perform any of the methods described herein. The program instructions 804 may be provided to the sensor device 100 on a computer-readable medium, which may be a tangible (non-transitory) product (e.g. magnetic medium, optical disk, read-only memory, flash memory, etc) or a transitory product, such as a propagating signal.

The memory 803 may be, for example, one or more of a buffer, a flash memory, a hard drive, a removable media, a volatile memory, a non-volatile memory, a random access memory (RAM), or other suitable device. In a typical arrangement, the memory 803 includes a non-volatile memory for long term data storage and a volatile memory that functions as system memory for the control circuit 801. As indicated in FIG. 8, the memory 803 may also store data 805 for use by the control circuit 801, e.g. the databases 330, 340 (FIG. 3), etc. The memory 803 may exchange data with the control circuit 801 over a data bus. Accompanying control lines and an address bus between the memory 803 and the control circuit 801 may also be present. In a variant, the memory 803 is at least partly located within the control circuit 801.

The transceiver 806 is configured for communication in accordance with any relevant wired or wireless communications standard. It is conceivable that the transceiver supports more than one communications standard. The transceiver 806 may be a unitary device or a combination of modules. In the illustrated example, the transceiver 806 is configured for wireless communication and connected to one or more antennas.

The sensor device 100 further comprises one or more input/output (I/O) interfaces 807. The I/O interface(s) 807 may be in the form of typical electronic device I/O interfaces and may include one or more electrical connectors for operatively connecting the sensor device 100 to one or more sensors by cable. Alternatively or additionally, one or more sensors may be integrated into the sensor device 100 and connected by wire to the control circuit 801 (not shown). Alternatively or additionally, one or more sensors may be wirelessly connected to the sensor device 100, e.g. through the transceiver 806. Further, operating power may be received over the I/O interface(s) 807, and power to charge a power supply unit (PSU) 808 within the sensor device 100 may be received over the I/O interface(s) 807. The PSU 808, e.g. comprising one or more batteries, may supply power to operate the sensor device 100 in the absence of an external power source.

1. A method, for use in a sensor device, said method comprising:
receiving input signal data of one or more sensors,
encoding the input signal data into formatted sensor data in a first format, and
transmitting the formatted sensor data to a receiving device over a communication channel,
wherein the method further comprises:
configuring, subject to a command said encoding to generate the formatted sensor data in a second format which differs from the first format.

2. The method of claim 1, wherein the formatted sensor data in the first format comprises one or more output parameters, and wherein said configuring comprises at least one of:
changing a physical unit of at least one of the one or more output parameters,
including at least one additional output parameter in the formatted sensor data,
switching between generating at least one of the one or more output parameters in a time domain and in a frequency domain,
changing frequency content represented by at least one of the one or more output parameters,
changing a number of frequency components that are included among the one or more output parameters,
changing a dynamic range of at least one of the one or more output parameters,
changing a sampling rate of at least part of the input signal data,
changing a transmission bit rate of at least one of the one or more output parameters,
changing a quantization of at least one of the one or more output parameters,
activating a differential coding of at least one of the one or more output parameters,
activating a parametric coding of at least one of the one or more output parameters,
activating a multiplexing of at least two output parameters when transmitting the one or more output parameters, and
controlling an autoencoder to generate at least one of the one or more output parameters by dimensionality reduction.

3. The method of claim 2, wherein said changing a number of frequency components further comprises one of: including only a fundamental frequency of the input signal data among the one or more output parameters, including a set of harmonics of the fundamental frequency among the one or more output parameters, and including a power spectrum representation of the input signal data among the one or more output parameters.

4. The method of claim 2, wherein said changing frequency content is based on masking data, which defines one or more of: a set of frequency ranges to be represented by the one or more output parameters, a quantization within one or more frequency ranges, a time-averaging within one or more frequency ranges, and a number of frequency components within one or more frequency ranges.

5. The method of claim 2, wherein said changing a quantization further comprises modifying a control parameter of a configurable dithering process.

6. The method of claim 1, wherein the command is received from the receiving device and is optionally generated by the receiving device by processing the formatted sensor data in the first format.

7. The method of claim 6, wherein the command is indicative of characteristics of the second format.

8. (canceled)

9. The method of claim 1, further comprising: performing an analysis of the input signal data to generate the command.

10. The method of claim 9, wherein the command is generated by the sensor device to automatically adapt the formatted sensor data to the input signal data.

11. The method of claim 9, wherein said analysis comprises: processing the input signal data in relation to a set of formatting criteria, said set of formatting criteria comprising one or more of:
detecting a repeating signal feature in the input signal data,
detecting an absence of a characteristic change in the input signal data,
determining, in the input signal data, a variability that falls below a variability threshold for a time period,
detecting a characteristic change in the input signal data,
detecting a change of sensor or sensor type,
detecting a change in complexity in the input signal data,
detecting a similarity between input signal data of two or more sensors or between two or more output parameters among the one or more output parameters, and
detecting a match between a predefined signal pattern and the input signal data.

12. (canceled)

13. The method of claim 11, wherein said analysis, when detecting the repeating signal feature, generates the command to include an index of the predefined signal pattern in the formatted sensor data or to switch to generating at least one of the one or more output parameters in the frequency domain.

14. The method of claim 11, wherein said analysis, when detecting the absence of a characteristic change, generates the command to reduce transmission bit rate and/or decrease quantization.

15. The method of claim 11, wherein said analysis, when determining the variability below a variability threshold for a time period, generates the command to reduce transmission bit rate and/or decrease quantization.

16. The method of claim 11, wherein said analysis, when detecting the characteristic change, generates the command to increase transmission bit rate and/or increase quantization.

17. The method of claim 11, wherein said analysis, when detecting the change in complexity, generates the command to change at least one of transmission bit rate and quantization.

18. The method of claim 11, wherein said analysis, when detecting the similarity, generates the command to switch to parametric coding.

19. The method of claim 11, wherein said analysis, when detecting the match, generates the command to include an index of the predefined signal pattern among said one or more output parameters.

20-21. (canceled)

22. The method of claim 11, wherein said analysis, when detecting the change of sensor or sensor type, generates the command to switch to one of parametric coding and differential coding.

23. (canceled)

24. A sensor device configured for connection to one or more sensors and configured to perform a method in accordance with claim 1.

25. A system comprising a sensor device in accordance with claim 24, and a receiving device configured to receive the formatted sensor data in the first format from the sensor device, wherein the receiving device is further configured to process the formatted sensor data in the first format for detection of a need to change format of the formatted sensor data, determine a second format that differs from the first format, and transmit a command to the sensor device so as to cause the sensor device to generate the formatted sensor data in the second format.
